(19) United States
(12) Patent Application Publication
(10) Pub. No.: US 2019/0018501 A1
(43) Pub. Date: Jan. 17, 2019

(54) KEY STRUCTURE

(71) Applicant: LITE-ON TECHNOLOGY CORPORATION, Taipei (TW)

(72) Inventors: Chun-Lin CHEN, Taipei (TW); Jui-Yu WU, Taipei (TW)

(21) Appl. No.: 15/991,152

(22) Filed: May 29, 2018

(30) Foreign Application Priority Data
Jul. 11, 2017 (CN) 201710561098.1

(51) Int. Cl. G06F 3/02; H01H 13/85

(52) U.S. Cl. CPC G06F 3/0202; H01H 13/85

(57) ABSTRACT

A key structure including a bottom plate, a pivoting structure, a cap, a thin-film circuit board and a dome structure is provided. The bottom plate has a limiting unit. The pivoting structure is slidably disposed on the bottom plate and includes a first pivoting member and a second pivoting member. The cap is disposed on the pivoting structure and connects the pivoting structure. The cap moves with respect to the bottom plate up and down through the rotation of the first pivoting member with respect to the second pivoting member. The thin-film circuit board is disposed on the bottom plate and includes a switch element. The dome structure is disposed against between the pivoting structure and the thin-film circuit board and includes a metal dome located above the switch element.

This application claims the benefit of People's Republic of China application Serial No. 201710561098.1, filed Jul. 11, 2017, the subject matter of which is incorporated herein by reference.

### BACKGROUND OF THE INVENTION

### Field of the Invention

The invention relates in general to a key structure, and more particularly to a key structure capable of improving the user's tactile sensation.

### Description of the Related Art

Along with the maturity of technology, the performance and design of the laptop computer is getting better and better, and the consumers are having higher and higher expectations of the keyboard. Regarding the quality requirements of the keyboard, each key needs to have a uniform backlight source. Furthermore, when a key is pressed, the user's tactile sensation must be comfortable and the course of key pressing must be short, such that the laptop computer can meet the requirements of lightweight, slimness, and compactness.

Currently, the cap of the power key of the laptop computer is supported by a rubber dome disposed under the cap. The cap of the power key normally has a special character printed thereon for the user to recognize. Since the power key is an independent key separated from the keyboard and cannot be integrally formed with the keyboard, the space utilization of the keyboard is inferior. Furthermore, since the structural design of the power key is different from that of the keys of the keyboard, the power key is disposed on the motherboard of the laptop computer and occupies extra space in the motherboard. This problem needs to be resolved.

### SUMMARY OF THE INVENTION

The invention is directed to a key structure, where the cap is supported by a metal dome and a scissor-type pivoting structure, such that the user's tactile sensation can be enhanced.

The invention is directed to a key structure whose pivoting structure has a light guiding portion and a light shielding portion formed by two injection molding materials, such that the key structure has both light guiding and light shielding functions.

According to one embodiment of the present invention, a key structure including a bottom plate, a pivoting structure, a cap, a thin-film circuit board and a dome structure is provided. The bottom plate has a limiting unit. The pivoting structure is slidably disposed on the bottom plate and includes a first pivoting member and a second pivoting member. The cap is disposed on the pivoting structure and connects the pivoting structure. The cap moves with respect to the bottom plate up and down through the rotation of the first pivoting member with respect to the second pivoting member. The thin-film circuit board is disposed on the bottom plate and includes a switch element. The dome structure is disposed against between the pivoting structure and the thin-film circuit board and includes a metal dome located above the switch element.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a partial explosion diagram of a key structure according to an embodiment of the invention.

FIG. 2A is a detailed explosion diagram of a key structure according to an embodiment of the invention.

FIG. 2B is a detailed explosion diagram of a key structure according to another embodiment of the invention.

FIG. 3 is an explosion diagram of a dome structure according to an embodiment of the invention.

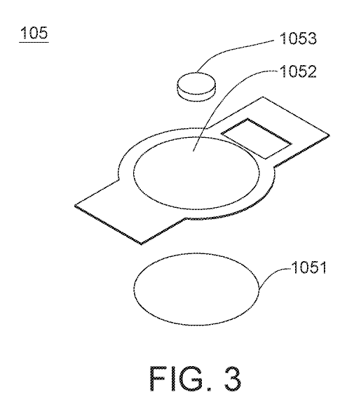

FIGS. 4A and 4B are cross-sectional views of the key structure of FIG. 1 along a segment line A-A.

FIG. 5 is a schematic diagram of an optical path of a key structure having light guiding and light shielding functions according to an embodiment of the invention.

### DETAILED DESCRIPTION OF THE INVENTION

Detailed descriptions of the invention are disclosed below with a number of embodiments. However, the disclosed embodiments are for explanatory and exemplary purposes only, not for limiting the scope of protection of the invention.

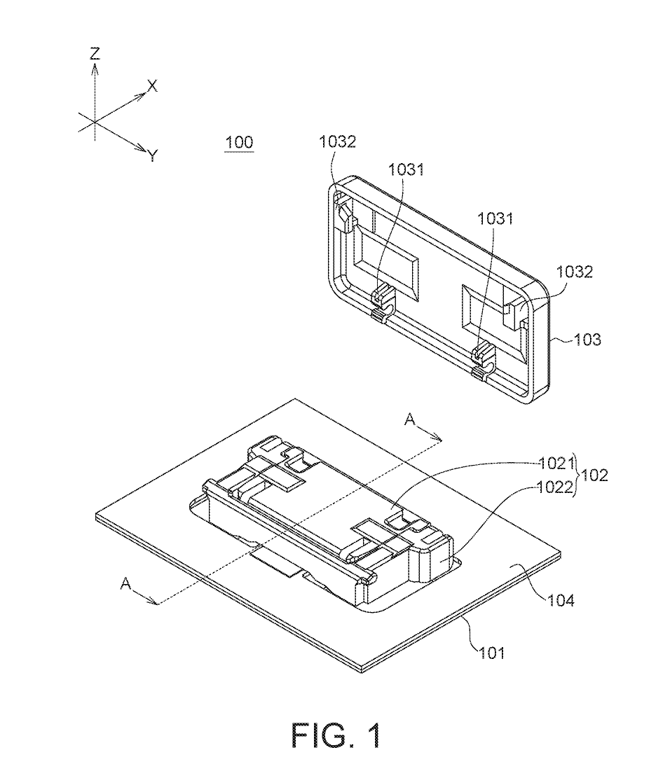

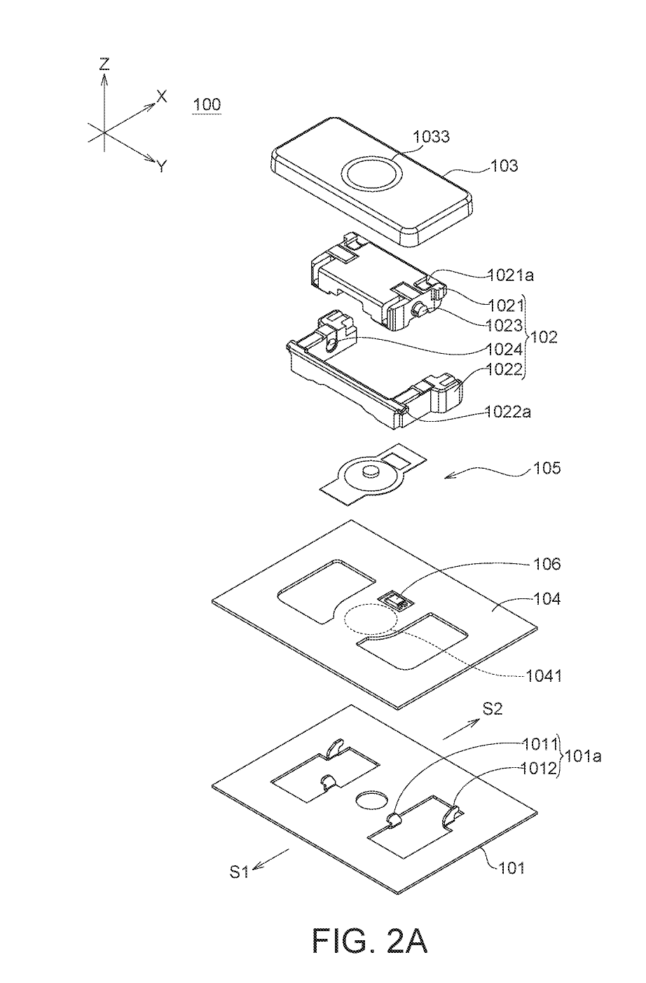

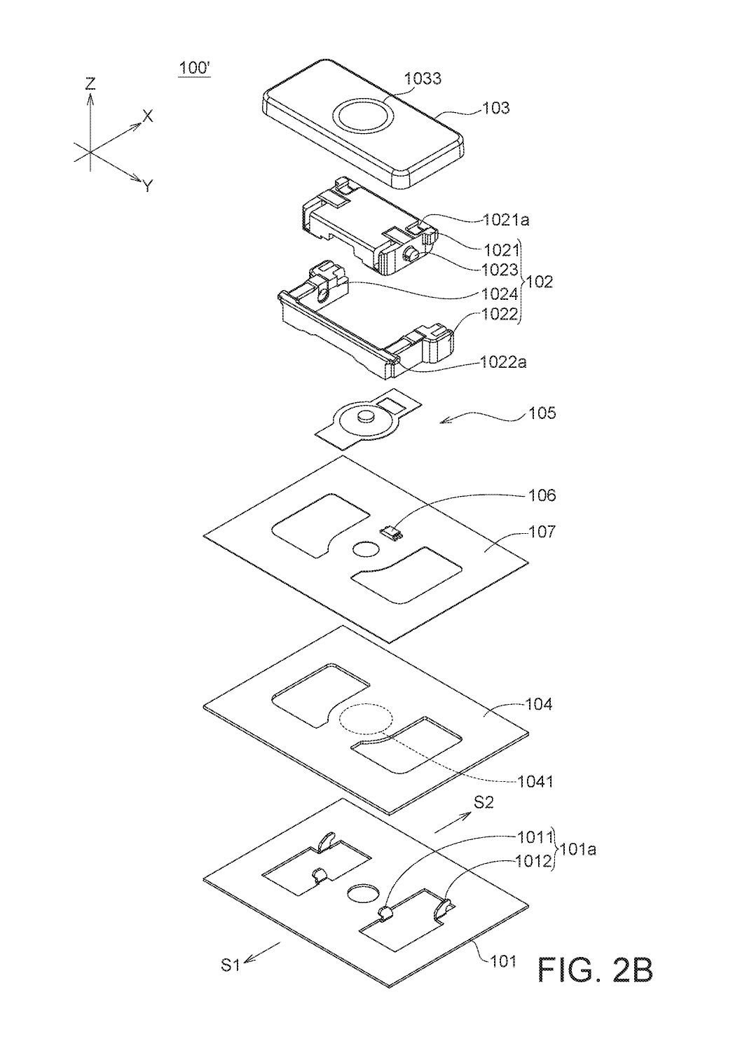

Refer to FIGS. 1 and 2A. The key structure 100 according to an embodiment of the invention includes a bottom plate 101, a pivoting structure 102, a cap 103, a thin-film circuit board 104 and a dome structure 105. The bottom plate 101 has a limiting unit 101a. The pivoting structure 102 is rotatably disposed on the bottom plate 101 and includes a first pivoting member 1021 and a second pivoting member 1022. The cap 103 is disposed on the pivoting structure 102 and connects the pivoting structure 102. The cap 103 moves with respect to the bottom plate 101 up and down through the rotation of the first pivoting member 1021 with respect to the second pivoting member 1022.

The limiting unit 101a includes at least one first sliding portion 1011 (two are illustrated in the diagram) and at least one second sliding portion 1012 (two are illustrated in the diagram). The first sliding portion 1011 and the second sliding portion 1012 form an L-shaped beak structure. The first sliding portion 1011 has an opening facing the first direction S1 (towards the negative direction of the X axis), and the second sliding portion 1012 has an opening facing the second direction S2 (towards the positive direction of the X axis). The first direction S1 is opposite to the second direction S2.

The first pivoting member 1021 and the second pivoting member 1022 respectively have a coupling shaft 1023 and a shaft hole 1024, and are pivotally connected to each other via the coupling shaft 1023 and the shaft hole 1024. The lower end of the first pivoting member 1021 can slide to the first sliding portion 1011 and be limited by the first sliding portion 1011. When the cap 103 is pressed, the lower end of the first pivoting member 1021 can move along the first direction S1. Besides, the lower end of the second pivoting member 1022 can slide to the second sliding portion 1012 and be limited by the second sliding portion 1012. When the cap 103 is pressed, the lower end of the second pivoting member 1022 can move along the second direction S2.

The cap 103 is disposed on the pivoting structure 102 and has at least one first positioning portion 1031 and at least one second positioning portion 1032, and the fixing shaft 1021a disposed at the upper end of the first pivoting member 1021 can be pivotally connected to the first positioning portion 1031, and the fixing shaft 1022a disposed at the upper end of the second pivoting member 1022 can rotatably move in the second positioning portion 1032.

The thin-film circuit board 104 is disposed on the bottom plate 101 and includes a switch element 1041. In an embodiment, the switch element 1041 includes an upper conducting layer and a lower conducting layer (not illustrated in the diagram), and the upper conducting layer and the lower conducting layer are separated by a gap. When the cap 103 is pressed, the switch element 1041 corresponding to the dome structure 105 is pressed, such that the upper conducting layer and the lower conducting layer contact each other and become conducted to generate a pressing signal.

The dome structure 105 is disposed against between the pivoting structure 102 and the thin-film circuit board 104 and includes a metal dome 1051 which is dome-shaped and located above the switch element 1041. In comparison to the conventional elastic dome formed of rubber, epoxy, semi-cured colloid or plastic material, the metal dome 1051 provides a tactile sensation better than that provided by a rubber dome.

In an embodiment, the dome structure 105 includes a polymer film layer 1052 covering the metal dome 1051 and formed of a polyester material. The metal dome 1051 can be fixed on the thin-film circuit board 104 via the polymer film layer 1052. The dome structure 105 can further include a protruding portion 1053 disposed on the polymer film layer 1052 and formed of polymer (such as a polyester material), and can be integrally formed with the polymer film layer 1052. The protruding portion 1053 is protruded above the polymer film layer 1052 and opposite to the pivoting structure 102. The protruding portion 1053 can enhance the user's pressing sensation and provides a better elastic restoring force. Moreover, the protruding portion 1053 has a thickness larger than that of the polymer film layer 1052, and therefore enhances the pressure resistance of the polymer film layer 1052 and reduces the probability of the polymer film layer 1052 being repeatedly pressed and becoming damaged.

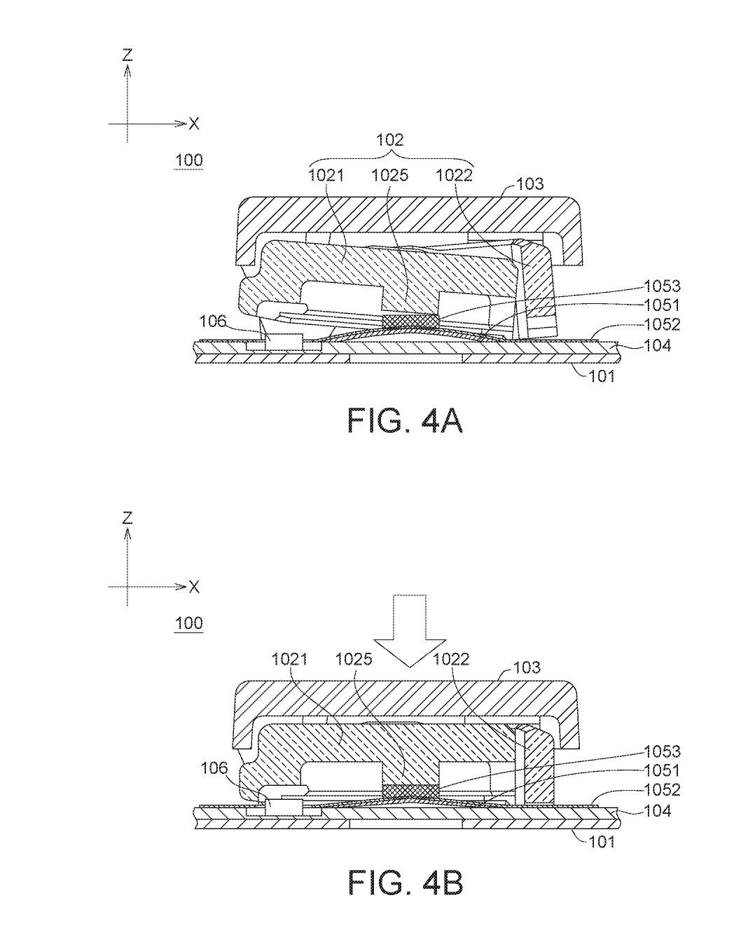

Refer to FIGS. 4A-4B. The pivoting structure 102 can further include an abutting part 1025 protruded under the first pivoting member 1021 (or the second pivoting member 1022) and contacts the dome structure 105. In an embodiment, the abutting part 1025 is correspondingly disposed above the protruding portion 1053 and presses the protruding portion 1053.

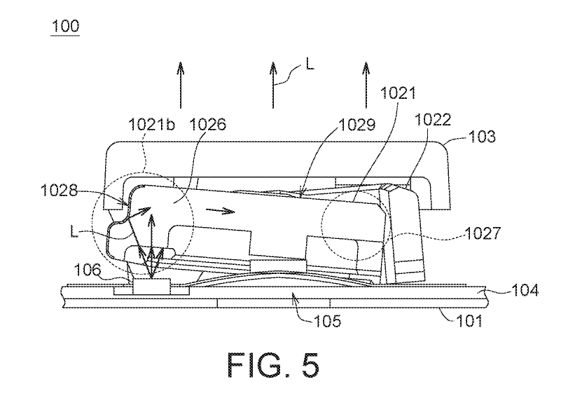

Refer to FIG. 2A and FIG. 5. The key structure 100 further includes a light emitting element 106 disposed on the thin-film circuit board 104 and used as a backlight source of the key structure 100. The light emitting element 106 can include one or multiple light emitting diodes. The first pivoting member 1021 (or the second pivoting member 1022) has a light guiding portion 1026 correspondingly disposed above the light emitting element 106. As indicated in FIG. 5, the light beam L emitted by the light emitting element 106 firstly enters the first pivoting member 1021, and then is reflected or scattered to a low light zone 1027 via the light guiding portion 1026. The low light zone 1027 is an area farther away from the light emitting element 106 or the light is not easy to arrive at. Then, the light beam L outputted from the surface of the first pivoting member 1021 is projected to the cap 103, such that the translucent region 1033 of the cap 103 (FIG. 1) can provide uniform brightness.

Refer to FIG. 2B, in another embodiment, the key structure 100′ further comprises a supporting member 107, such as a thin-film or a mylar. The light emitting element 106 can be disposed on the supporting member 107, and a power source can be supplied to the light emitting element 106 through the circuit on the thin-film. The supporting member 107 can be disposed between the cap 103 and the thin-film circuit board 104, and the supporting member 107 and the thin-film circuit board 104 have different functions.

In an embodiment, the translucent region 1033 of the cap 103 can be a light source indicating region or a character region. The character region disposed on the cap 103 is a translucent region indicating an English alphabet, a number, a phonetic symbol, a function symbol or a power symbol. The key structure 100 of the invention can be anyone key of a standard keyboard or a specific power key, and the invention does not impose specific restriction.

In the present embodiment, the first pivoting member 1021 may contain a translucent material, and the second pivoting member 1022 may contain an opaque material. In another embodiment, the first pivoting member 1021 may contain an opaque material, and the second pivoting member 1022 may contain a translucent material. That is, one of the first pivoting member 1021 and the second pivoting member 1022 has a light guiding function (equivalent to the light guiding portion 1026), and the other one of the first pivoting member 1021 and the second pivoting member 1022 has a light shielding function (equivalent to the light shielding portion 1028), such that the key structure 100 has both light guiding and light shielding functions and can avoid light leaking.

Refer to FIG. 5. In an embodiment, the light guiding portion 1026 can be located at a partial region 1021b (correspondingly disposed above the light emitting element 106) of the first pivoting member 1021 (or the second pivoting member 1022) containing a translucent material, and the key structure 100 may further include a light shielding portion 1028 covering the surface of the partial region 1021b. The light shielding portion 1028 contains a black pigment for absorbing or reflecting the light to void light leakage. That is, the light emitted by the light emitting element 106 is absorbed or reflected by the light shielding portion 1028, and will not be leaked via the lateral side of the cap 103. In an embodiment, the light guiding portion 1026 is formed by an injection molding material. The light shielding portion 1028 can be formed by another injection molding material or a coating material. The light guiding portion 1026 and the light shielding portion 1028 can be integrally formed by way of double injection molding. Therefore, the key structure 100 can achieve light guiding and light shielding effects through the light guiding portion 1026 and the light shielding portion 1028.

In an embodiment, the first pivoting member 1021 (or the second pivoting member 1022) containing the translucent material has an atomized surface 1029 facing the bottom surface of the cap 103. The atomized surface 1029 can be formed by using a printing process, a rolling process, a sand blasting process or a texturing process, such that the backlight can produce an atomization effect. That is, the light beam L emitted by the light emitting element 106 is scattered by the atomized surface 1029 to achieve a uniform output effect. In addition to the sand blasting process and the texture process, other surface treatment techniques can be applied on the atomized surface 1029 such that the atomized surface 1029 can scatter the light or deflect the light at multi-angles to achieve an atomization effect.

The key structure disclosed in above embodiments of the invention can be adaptively used as a power key of a laptop computer. In the invention, the cap is supported by a metal dome and a scissor-type pivoting structure, such that the user's tactile sensation can be enhanced. In the invention, the power key can be integrally formed with a keyboard of a laptop computer to increase the space utilization of the keyboard. In the invention, the power key is disposed on the thin-film circuit board of the keyboard instead of the motherboard of the laptop computer, and therefore occupies less space of the motherboard. Moreover, in the invention, the power key can display a character using the light uniformly outputted from the light guiding portion, such that high quality display effect can be achieved.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A key structure, comprising:
a bottom plate having a limiting unit;
a pivoting structure rotatably disposed on the bottom plate and comprising a first pivoting member and a second pivoting member;
a cap disposed on the pivoting structure and connecting the pivoting structure, wherein the cap moves with respect to the bottom plate up and down through the rotation of the first pivoting member with respect to the second pivoting member;
a thin-film circuit board disposed on the bottom plate and comprising a switch element; and
a dome structure disposed against between the pivoting structure and the thin-film circuit board and comprising a metal dome disposed above the switch element.

2. The key structure according to claim 1, wherein the dome structure further comprises a polymer film layer covering the metal dome.

3. The key structure according to claim 2, wherein the dome structure further comprises a protruding portion located on the polymer film layer.

4. The key structure according to claim 1, wherein the pivoting structure further comprises an abutting part protruded under the first pivoting member or the second pivoting member and contacting the dome structure.

5. The key structure according to claim 1, further comprising a light emitting element disposed on the thin-film circuit board, wherein the first pivoting member or the second pivoting member has a light guiding portion correspondingly located above the light emitting element.

6. The key structure according to claim 5, wherein the light guiding portion is located in a partial region of the first pivoting member or the second pivoting member and formed by an injection molding material.

7. The key structure according to claim 6, further comprising a light shielding portion covering a surface of the partial region and formed by another injection molding material.

8. The key structure according to claim 6, further comprising a light shielding portion covering a surface of the partial region and formed by a coating material.

9. The key structure according to claim 1, further comprising a light emitting element and a supporting member, wherein the light emitting element is disposed on the supporting member, and the supporting member is disposed between the cap and the thin-film circuit board.

10. The key structure according to claim 9, wherein the first pivoting member or the second pivoting member has a light guiding portion correspondingly located above the light emitting element.

11. The key structure according to claim 10, wherein the light guiding portion is located in a partial region of the first pivoting member or the second pivoting member and formed by an injection molding material.

12. The key structure according to claim 11, further comprising a light shielding portion covering a surface of the partial region and formed by another injection molding material.

13. The key structure according to claim 11, further comprising a light shielding portion covering a surface of the partial region and formed by a coating material.

14. The key structure according to claim 1, wherein one of the first pivoting member and the second pivoting member contains a translucent material, and the other one of the first pivoting member and the second pivoting member contains an opaque material.

15. The key structure according to claim 14, wherein the first pivoting member or the second pivoting member containing the translucent material has an atomized surface facing a bottom surface of the cap.

16. The key structure according to claim 15, wherein the atomized surface is formed by using a printing process, a rolling process, a sand blasting process or a texturing process.

17. The key structure according to claim 1, adaptively used as a power key of a laptop computer integrally formed with a keyboard of the laptop computer.

18. The key structure according to claim 17, wherein the cap has a translucent region used as a light source indicating region or a character region of the power key.
